(19) United States
(12) Patent Application Publication
(10) Pub. No.: US 2024/0013356 A1
(43) Pub. Date: Jan. 11, 2024

(54) METHOD FOR GENERATING HIGH DYNAMIC RANGE IMAGE, AND IMAGE PROCESSING SYSTEM

(71) Applicant: SONIC STAR GLOBAL LIMITED, TORTOLA (VG)

(72) Inventor: YING-RU CHEN, MIAOLI COUNTY (TW)

(21) Appl. No.: 17/811,087

(22) Filed: Jul. 7, 2022

(51) Int. Cl. G06T 5/00; H04N 9/64; G06T 5/50; H04N 7/00

(52) U.S. Cl. CPC G06T 5/009; H04N 9/646; G06T 5/50; H04N 7/005; G06T 2207/20208; G06T 2207/10024

(57) ABSTRACT

A method for generating high dynamic range (HDR) image data is provided. The method includes: performing image enhancement on first image data represented in a first color space, and accordingly generating second image data, in which the first image data is produced using a first opto-electronic transfer function for standard dynamic range (SDR) content; converting the second image data into third image data represented in a second color space, in which a color gamut of the second color space is wider than a color gamut of the first color space; performing dynamic range adjustment on the third image data to generate fourth image data, in which the bit depth of the fourth image data is greater than the bit depth of the third image data; and converting the fourth image data into the HDR image data based on a second opto-electronic transfer function for HDR content.

### BACKGROUND

The present disclosure relates to image processing and, more particularly, to a method for generating high dynamic range images, and an image processing system.

High dynamic range (HDR) capacity has become a key selling point for display manufacturers. HDR video technology can provide information about brightness and color across a much wider range, thereby reproducing what the naked eye sees in colors and in contrast between the brightest whites and the darkest blacks. HDR-compatible displays can read that information and show an image built from a wider color gamut and brightness. With the HDR video technology, it is possible to recreate image realism from cameras to displays. However, there is a need in the art for an improved design to reduce the artifacts resulting from the image processing on HDR images by an image signal processor (ISP).

### SUMMARY

The described embodiments provide a method for generating high dynamic range images, and an image processing system.

Some embodiments described herein may include a method for generating high dynamic range (HDR) image data. The method includes: performing image enhancement on first image data represented in a first color space, and accordingly generating second image data, in which the first image data is produced using a first opto-electronic transfer function for standard dynamic range (SDR) content; converting the second image data into third image data represented in a second color space, in which a color gamut of the second color space is wider than a color gamut of the first color space; performing dynamic range adjustment on the third image data to generate fourth image data, in which the bit depth of the fourth image data is greater than the bit depth of the third image data; and converting the fourth image data into the HDR image data based on a second opto-electronic transfer function for HDR content.

Some embodiments described herein may include a method for generating high dynamic range (HDR) image data. The method includes: performing tone mapping and color correction on input image data to generate first image data represented in a color space having a color gamut compatible with HDR content, in which the bit depth of the first image data is less than the bit depth of the input image data; performing dynamic range adjustment on the first image data to generate second image data, in which the second image data and the input image data are of equal bit depth; converting the second image data into third image data based on an opto-electronic transfer function supporting the HDR content; and performing image enhancement on the third image data, and accordingly generating the HDR image data.

Some embodiments described herein may include an image processing system. The image processing system includes a memory and an image signal processor. The memory is configured to store output image data corresponding to input image data captured by an image sensor. The image signal processor is coupled to the memory. The image signal processor is configured to: convert the input image data into first image data represented in a first color space based on a first opto-electronic transfer function supporting a first dynamic range; perform image enhancement on the first image data to generate second image data; convert the second image data into third image data represented in a second color space, in which a color gamut of the second color space is wider than a color gamut of the first color space; perform dynamic range adjustment on the third image data to generate fourth image data, in which the bit depth of the fourth image data is greater than the bit depth of the third image data; and apply a second opto-electronic transfer function to the fourth image data, and accordingly generate the output image data, in which the second opto-electronic transfer function supports a second dynamic range wider than the first dynamic range.

With the use of the proposed image processing scheme, an image signal processor (ISP) end can generate HDR image data without, or almost without, introducing artifacts caused by image enhancement. The ISP end can provide a display end with an HDR video stream having a dynamic range equal to that of the image stream captured by an image sensor. Moreover, the proposed image processing scheme can realize an ISP-guided video system or a quality-aware end-to-end video system, which outputs metadata from the ISP end to the display end for further image processing.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating an exemplary video system in accordance with some embodiments of the present disclosure.

FIG. 2 illustrates examples of the opto-electronic transfer functions shown in FIG. 1 in accordance with some embodiments of the present disclosure.

FIG. 3 is a diagram illustrating an exemplary ISP pipeline at the ISP end shown in FIG. 1 in accordance with some embodiments of the present disclosure.

FIG. 4 is a flow chart of an exemplary method for generating HDR image data in accordance with some embodiments of the present disclosure.

FIG. 5 is a diagram illustrating an exemplary ISP pipeline at the ISP end shown in FIG. 1 in accordance with some embodiments of the present disclosure.

FIG. 6 is a flow chart of an exemplary method for generating HDR image data in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

The pre-processing of video images may include applying a one-dimensional color component transform to linear light RGB components and/or to the luminance components. Such transforms optimize the quantization of captured light information, often by modeling aspects of human vision. One such transform is the correction function called Opto-Electrical Transfer Function (OETF). An image signal processor (ISP) may apply an OETF to correct input image data for further image processing, such as noise reduction and image sharpening. For example, in an ISP pipeline for generating a standard dynamic range (SDR) image, the ISP will apply an OETF supporting SDR content to correct the input image data. After that, the ISP can perform image enhancement upon the corrected image data, thereby generating the SDR image. Similarly, in an ISP pipeline for generating an HDR image, the ISP will apply an OETF supporting HDR content to correct the input image data. However, as the OETF used for HDR content exhibits a steep slope in the low luminance range, performing image enhancement on the such corrected image data will cause artifacts in the HDR image, e.g. edge overshoots and/or dark region noises. For an end-to-end HDR system, post-processing of the HDR image needs to reduce the artifacts.

The present disclosure describes exemplary methods for generating HDR image data. Each method can perform image enhancement on image data having a wide dynamic range without, or almost without, introducing artifacts into the resulting image data, thereby outputting the HDR image data to a display end. In addition, the method can maintain a dynamic range of the HDR image data equal to that of input image data received from an image sensor. Note that the term “image data” as used herein may refer to still image data or frame data of a video stream. The present disclosure further describes exemplary image processing systems, each of which can be used to implement a quality-aware end-to-end video system that covers an ISP end and a display end. The image processing system is located at the ISP end, and is configured to provide the display end with metadata which may include tone mapping parameters and/or image enhancement parameters. The display end can present high quality HDR video content based on the metadata. Further description is provided below.

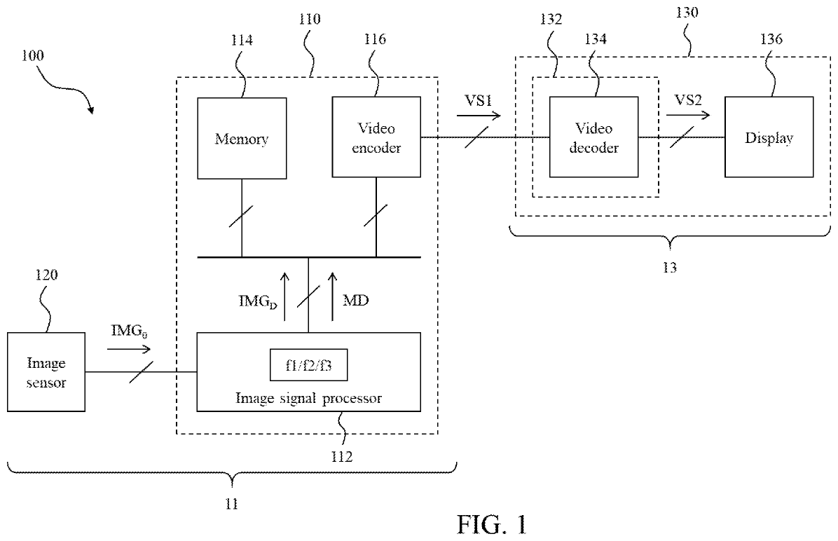

FIG. 1 is a diagram illustrating an exemplary video system in accordance with some embodiments of the present disclosure. The video system 100 can be implemented as a quality-aware end-to-end HDR video system, which supports video preview, video recording, and/or video playback. The video system 100 may include an ISP end 11 and a display end 13. In some embodiments, the ISP end 11 and the display end 13 may be integrated into an electronic device such as a smartphone. The display device 130 at display end 13 is built into the electronic device. In some embodiments, the ISP end 11 and the display end 13 may be located in two separate electronic devices. For example, the ISP end 11 is located in a smartphone, while the display device 130 is external to the smartphone.

The ISP end 11 can output an encoded video stream VS1 to the display end 13. The encoded video stream VS1 may incorporate the metadata MD that includes parameters indicative of image/video quality. The display end 13 can receive the encoded video stream VS1 to get aware of the video quality, and display video content based on the encoded video stream VS1.

For example, at the ISP end 11, the image processing system 110 is configured to process the input image data IMG₀ captured by the image sensor 120, and accordingly generate the encoded video stream VS1. The image processing system 110 may include an ISP 112, a memory 114, and a video encoder 116. The ISP 112 is configured to process the input image data IMG₀ to generate the output image data IMG_{D}. The output image data IMG_{D} can have the same or substantially the same dynamic range as the input image data IMG₀. The memory 114, coupled to the ISP 112, is configured to store the output image data IMG_{D}. The memory 114 can be implemented as a dynamic random access memory (DRAM), a flash memory, or other types of storage elements. The video encoder 116, coupled to the ISP 112, is configured to encode the output image data IMG_{D} into the encoded video stream VS1.

In addition, the ISP 112 can be configured to generate the metadata MD which includes parameters indicative of image/video quality, such as tone mapping parameters and/or image enhancement parameters. The video encoder 116 may encode the metadata MD along with the output image data IMG_{D} to produce the encoded video stream VS1. By way of example but not limitation, the metadata MD may be embedded in the header of the encoded video stream VS1.

The display device 130 at the display end 13 includes a processing circuit 132 and a display 136. The video decoder 134 included in the processing circuit 132 can decode the encoded video stream VS1 to generate the decoded video stream VS2. The display 136 can display HDR content based on the decoded video stream VS2. In the present embodiment, the display pipeline at the display end 13 can perform further processing according to the metadata MD included in the encoded video stream VS1. For example, the video decoder 134 can extract the metadata MD from the encoded video stream VS1. The processing circuit 132 can adaptively perform tone mapping on the received image data based on the extracted metadata MD and the dynamic range of the display 136.

In some embodiments, the ISP 112 can be configured to perform image enhancement on first image data represented in a first color space with a first color gamut. The first image data is produced using an OETF f1 supporting a first dynamic range. In addition, the ISP 112 can convert the resulting image data into second image data based on an OETF f2 supporting a second dynamic range wider than the first dynamic range. The second image data is represented in a second color space with a second color gamut wider than the first color gamut. For example, the OETF f1 is an OETF supporting SDR content (referred to as an SDR OETF), and the first color space is supported by an SDR device. The OETF f2 is an OETF supporting HDR content (referred to as an HDR OETF), and the second color space is used by an HDR standard. The ISP 112 can generate the output image data IMG_{D} according to the second image data which is compliant with the HDR standard. As the image enhancement is performed on the first image data which is produced using the SDR OETF, the ISP 112 can produce HDR images without introducing artifacts.

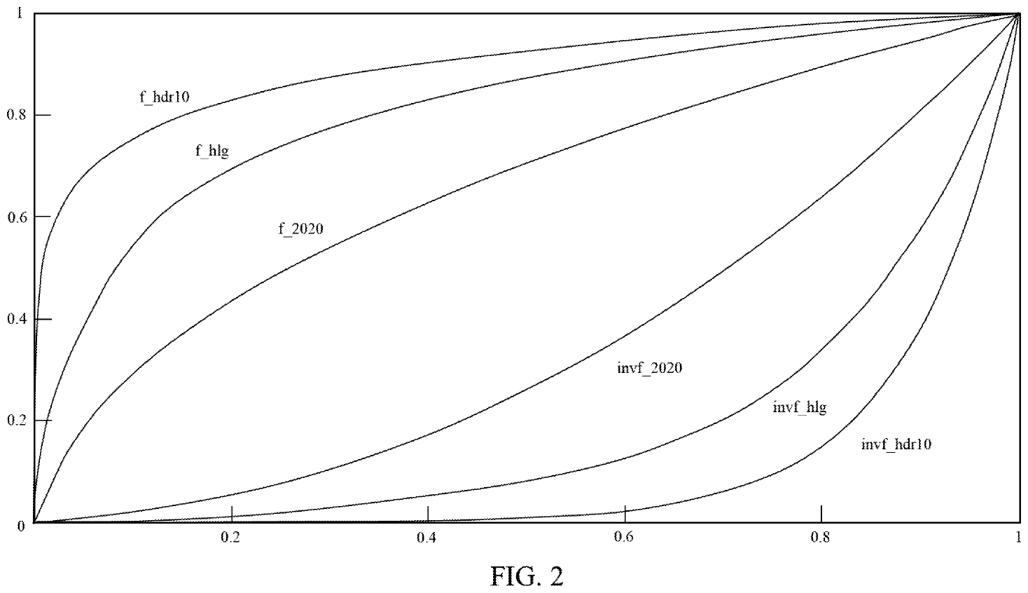

FIG. 2 illustrates examples of the OETFs f1 and f2 shown in FIG. 1 in accordance with some embodiments of the present disclosure. As can be seen, FIG. 2 also illustrates the mathematical inverse of the OETF, which is also known as the electro-optical transfer function (EOTF). The OETF f_2020 and the EOTF invf_2020 are defined in the ITU-R BT.2020 standard. The OETF f_2020 is an SDR OETF. The OETF f_hlg and the EOTF invf_hlg are standardized in the ITU-R BT.2100. The OETF f_hlg is the hybrid log-gamma (HLG) transfer function, which is an HDR OETF backward compatible with the transfer function used for SDR content. The OETF f_hdr10 and the EOTF invf_hdr10 are defined in the SMPTE ST.2084 standard. The OETF f_hdr10 is the perceptual quantizer (PQ) transfer function, which is an HDR OETF exhibiting a steeper slope than the OETF f_hlg in the low luminance range. By way of example but not limitations, the OETF f1 shown in FIG. 1 can be implemented using the OETF f_2020, and the OETF f2 shown in FIG. 1 can be implemented using one of the OETF f_hlg and the OETF f_hdr10. However, this is not intended to limit the scope of the present disclosure. In some embodiments, the OETFs f1 and f2 shown in FIG. 1 can be implemented using other OETFs without departing from the scope of the present disclosure as long as the OETF f2 supports a wider dynamic range than the OETF f1.

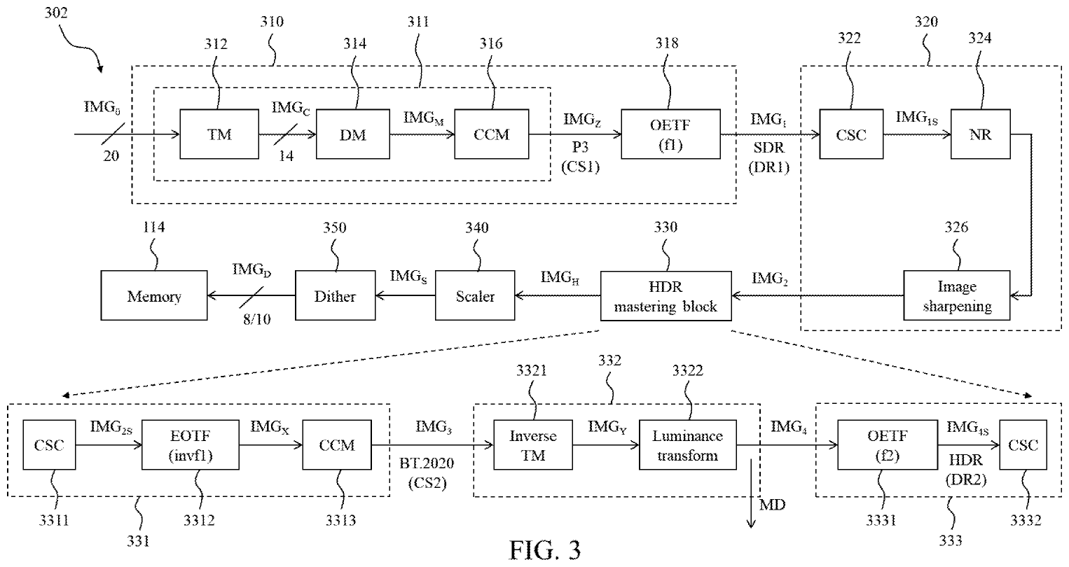

FIG. 3 is a diagram illustrating an exemplary ISP pipeline at the ISP end 11 shown in FIG. 1 in accordance with some embodiments of the present disclosure. The ISP pipeline 302 can be implemented by the ISP 112 shown in FIG. 1. For example, the ISP 112 shown in FIG. 1 may include hardware elements (e.g. dedicated circuitry) that facilitate the performance of various stages/blocks in the ISP pipeline 302. As another example, the ISP 112 shown in FIG. 1 may include software elements (e.g. a non-transitory computer-readable medium storing computer code) that facilitate the performance of various stages/blocks in the ISP pipeline 302. As still another example, the ISP 112 shown in FIG. 1 may include a combination of both hardware and software elements that facilitate the performance of various stages/blocks in the ISP pipeline 302.

The ISP pipeline 302 is configured to utilize the OETFs f1 and f2 shown in FIG. 1 to produce HDR video content without introducing artifacts. For illustrative purposes, the OETFs f1 and f2 used by the ISP pipeline 302 are implemented using the OETFs f_2020 and f_hdr10 shown in FIG. 2, respectively. Those skilled in the art will appreciate that other OETFs can be used as the OETFs f1 and f2 without departing from the scope of the present disclosure as long as the OETF f2 supports a wider dynamic range than the OETF f1.

In the present embodiment, the stage 310 in the ISP pipeline 302 can convert the input image data IMG₀ into the image data IMG₁ based on the OETF f1 supporting a dynamic range DR1. The input image data IMG₀ can be raw image data captured by the image sensor 120 shown in FIG. 1. The image data IMG₁, represented in a color space CS1, can be used to reproduce the captured raw image data on the display 136. The dynamic range DR1 may be a standard dynamic range. The OETF f1 may be an SDR OETF such as the OETF f_2020 shown in FIG. 2. The color space CS1 can be a color space having a color gamut supported by an SDR display. For example, the color space CS1 may be a P3 color space (i.e. a DCI-P3 or Display P3 color space) having a color gamut supported by a wide-gamut SDR display.

The stage 310 may include a processing block 311 and an OETF block 318. The processing block 311 is configured to convert the input image data IMG₀ into the image data IMG_{Z} represented in the color space CS1. The processing block 311 includes, but is not limited to, a tone mapping (TM) block 312, a demosaicing (DM) block 314, and a color correction matrix (CCM) block 316. The TM block 312 can perform tone mapping, e.g. local tone mapping (LTM), on the input image data IMG₀ to compress the range of pixel value of the input image data IMG₀. For example, the input image data IMG₀ may be 20 bits in length or depth per pixel. The tone-mapped image data generated by the TM block 312, i.e. the image data IMG_{C}, may be 14 bits in length or depth per pixel. In addition, the DM block 314 can perform the process of demosaicing the image data IMG_{C} to get full-color image data IMG_{M}. The CCM block 316 can apply color correction to the image data IMG_{M} through gamut mapping to generate the image data IMG_{Z} represented in the color space CS1. The OETF block 318 is configured to apply the OETF f1 to the image data IMG_{Z} to produce the image data IMG₁ with standard dynamic range (SDR).

The stage 320 is configured to perform image enhancement on the image data IMG₁ to generate enhanced image data IMG₂. The image enhancement may include at least one of noise reduction and image sharpening. In other words, the stage 320 can perform the noise reduction and/or the image sharpening on the image data IMG_{C}. Note that the image enhancement performed in the stage 320 may include other operations, such as contrast enhancement, without departing from the scope of the present disclosure.

The stage 320 includes, but is not limited to, a color space conversion (CSC) block 322, a noise reduction (NR) block 324, and an image sharpening block 326. The CSC block 322 can convert the image data IMG₁ from one color domain to another color domain, and accordingly generate the image data IMG_{1S}. In the example of FIG. 3, the CSC block 322 can convert the image data IMG₁ from an RGB color domain to a YUV color domain. The image data IMG_{1S}, i.e. the image data IMG₁ represented in the YUV domain, will undergo the respective operations performed by the NR block 324 and the image sharpening block 326 in sequence.

The stage 330 is configured to convert the image data IMG₂ into the image data IMG_{H} with a dynamic range DR2 wider than the dynamic range DR1. The image data IMG_{H} may be HDR image data. In other words, the dynamic range DR2 may be a high dynamic range compliant with the HDR standards. The stage 330 can be referred to as an HDR mastering block. In addition, the image data IMG_{H} is represented in a color space CS2 with a color gamut wider (larger) than that of the color space CS1. For example, the color space CS2 may be a BT.2020 color space defined in the HDR10 standard.

The stage 330 includes a number of processing blocks 331-333. The processing block 331 is configured to convert the image data IMG₂ into the image data IMG₃ represented in the color space CS2. In the present embodiment, the processing block 331 may include a CSC block 3311, an EOTF block 3312, and a CCM block 3313. The CSC block 3311 can convert the image data IMG₂ from the YUV color domain to the RGB color domain and accordingly, generate the image data IMG_{2S}. The OETF block 3312 can convert the image data IMG_{2S}, i.e. the image data IMG₂ represented in the RGB domain, into the image data IMG_{X} based on an EOTF invf1. The image data IMG_{X} is represented in the color space CS1 (e.g. the P3 color space). The EOTF invf1 may be an inverse of the OETF f1 used in the OETF block 318. The CCM block 3313 can apply color correction to the image data IMG_{X} through gamut mapping to generate the image data IMG₃ represented in the color space CS2 (e.g. the BT.2020 color space).

The processing block 332 is configured to perform dynamic range adjustment on the image data IMG₃ to generate the image data IMG₄. The processing block 332 can compensate for the loss of dynamic range. For example, the bit depth of the image data IMG₄ is greater than the bit depth of the image data IMG₃. In addition, the image data IMG₄ and the input image data IMG₀ may be of equal bit depth.

The processing block 332 may include an inverse tone mapping block 3321 and a luminance transform block 3322. The inverse tone mapping block 3321 can perform inverse tone mapping on the image data IMG₃ to produce image data IMG_{Y} having a bit depth greater than that of the image data IMG₃. Moreover, the image data IMG_{Y} and the input image data IMG₀ may be of equal bit depth. In other words, the inverse tone mapping block 3321 can recover or at least partially recover the range of pixel value compressed by the TM block 312.

The luminance transform block 3322 can remap luminance values of the image data IMG_{Y} to a predetermined luminance range, thereby generating the image data IMG₄ having the remapped luminance values that span the predetermined luminance range. The luminance transform block 3322 may set the predetermined luminance range according to user requirements or mapping criteria. For example, the lowest luminance value of the remapped image data IMG₄ may be equivalent to a predetermined brightness level or a minimum brightness level of the display 136. As another example, the highest luminance value of the remapped image data IMG₄ may be equivalent to a predetermined brightness level or a maximum brightness level of the display 136. As still another example, the minimum and maximum brightness levels of the display 136 can serve as the lower and upper bounds of the predetermined luminance range, respectively.

In some embodiments, the processing block 332 can be configured to output the metadata MD to a display device. The outputted metadata MD may include information about the predetermined luminance range, and/or include at least one parameter used in the image enhancement. For example, referring to FIG. 1 and FIG. 3, the metadata MD outputted from the ISP end 11 can be incorporated into the encoded video stream VS1, which is outputted to the display device 130 at the display end 13. When the metadata MD includes information about the predetermined luminance range used in the processing block 332, the processing circuit 132 may adaptively perform tone mapping on image data in the decoded video stream VS2 based on the metadata MD and the dynamic range of the display 136. When the metadata MD includes parameter(s) of noise reduction, contrast correction/enhancement, and/or image sharpening used in the stage 320, the processing circuit 132 can perform further image enhancement on the decoded video stream VS2 according to the metadata MD.

Referring again to FIG. 3, the processing block 333 is configured to apply the OETF f2 to the image data IMG₄, and accordingly generate the image data IMG_{H}. The dynamic range DR2 supported by the OETF f2 may be a high dynamic range. The OETF f2 may be an HDR OETF such as the OETF f_hdr10 shown in FIG. 2. In the embodiment shown in FIG. 3, the processing block 3331 may include an OETF block 3331 and a CSC block 3332. The OETF block 3311 can apply the OETF f2 to the image data IMG₄ to thereby produce the image data IMG_{4S} with the high dynamic range DR2. The CSC block 3332 can convert the image data IMG_{4S} from the RGB color domain to the YUV color domain. The image data IMG_{4S} represented in the YUV color domain can serve as the image data IMG_{H}.

The scaler block 340 is configured to scale the image data IMG_{H} to a size fitting a display such as the display 136. For example, the scaler block 340 can perform scaling, cropping and/or resizing operation on the image data IMG_{H}, thereby generating the scaled image data IMG_{S}. The dither block 350 can be configured to perform dithering on the image data IMG_{S} to generate the image data IMG_{D} with a bit depth less than that of the image data IMG_{S}. For example, the image data IMG_{D} may be an 8-bit or 10-bit format compatible with an HDR standard.

In operation, the processing block 311 can convert the input image data IMG₀ into the image data IMG_{Z} encoded in a P3 color space. The OETF block 318 can apply an SDR OETF (e.g. the OETF f_2020 shown in FIG. 2) to the image data IMG_{Z}, thereby producing the image data IMG₁ which is gamma compressed. The stage 320 can perform image enhancement, including noise reduction and image sharpening, on the image data IMG₁. Thereafter, the processing block 331 can convert the resulting image data IMG₂ into the image data IMG_{X} by gamma expansion based on the EOTF invf1 (e.g. the EOTF invf_2020 shown in FIG. 2). In addition, the processing block 331 can convert the image data IMG_{X} into the image data IMG₃ encoded in a BT.2020 color space.

Next, the processing block 332 can perform the inverse local tone mapping on the image data IMG₃ to recover the range of pixel value compressed in the processing block 311. For example, the TM block 312 is configured to perform LTM to compress the pixel vales of the input image data IMG₀ from 20 to 14 bits in depth, while the inverse tone mapping 3321 can perform the inverse LTM to recover the bit depth of the image data IMG₃ from 14 to 20 bits. In addition, the processing block 332 can adjust the absolute luminance values to improve the overall quality of the video content. For example, the luminance transform block 3322 can remap luminance values of the image data IMG_{Y} to a predetermined luminance range such that the lowest scene luminance value of the image data IMG_{Y} is projected to a predetermined brightness level of the display 136. The processing block 333 can apply the OETF f2 (e.g. the OETF f_hdr10 shown in FIG. 2) to the image data IMG₄ outputted from the processing block 332, thereby producing HDR image data (i.e. the image data IMG_{H}).

Furthermore, the processing block 332 can generate the metadata MD including parameters indicative of image/video quality, such as tone mapping parameter(s) and/or image enhancement parameter(s). The metadata MD can be incorporated into the encoded video stream VS1 shown in FIG. 1. The display device 130 shown in FIG. 1 can receive the encoded video stream VS1 to get aware of the video quality.

With the use of the proposed image processing scheme, a display device can receive a video stream having a dynamic range equal to, or substantially equal to, that of image data captured by an image sensor. In addition, the proposed image processing scheme can produce HDR image data without introducing artifacts caused by image enhancement. Moreover, the proposed image processing scheme can output metadata, including parameters indicative of image/video quality, for image processing in a display pipeline.

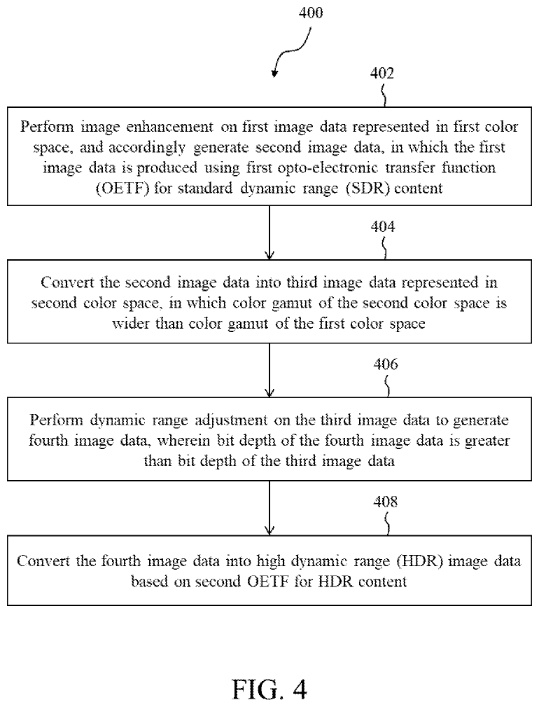

FIG. 4 is a flow chart of an exemplary method for generating HDR image data in accordance with some embodiments of the present disclosure. The operation described above with reference to the ISP pipeline 302 shown in FIG. 3 may be summarized in the flow chart of FIG. 4. For illustrative purposes, the method 400 is described below with reference to the ISP pipeline 302 shown in FIG. 3. Note that the method 400 can be employed by the ISP 112 shown in FIG. 1 for generating HDR image data without departing from the scope of the present disclosure. Moreover, in some embodiments, other operations in the method 400 can be performed.

At operation 402, image enhancement is performed on first image data represented in a first color space to thereby generate second image data. The first image data is produced using a first OETF for SDR content. For example, the stage 320 may receive the image data IMG₁ represented in the color space CS1 (e.g. a P3 color space), and perform image enhancement on the image data IMG₁ to generate the image data IMG₂. The image data IMG₁ is produced using the OETF f1, which may be the OETF f_2020 shown in FIG. 2.

In some embodiments, the first image data is generated by applying the first OETF to image data derived from input images captured by an image sensor. For example, the processing block 311 may perform tone mapping and color correction on the input image data IMG₀ to generate the image data IMG_{Z}. The OETF f1 is applied to the image data IMG_{Z} to produce the image data IMG₁.

At operation 404, the second image data is converted into third image data represented in a second color space. The second color space has a color gamut wider than that of the first color space. For example, the processing block 331 can convert the image data IMG₂ into the image data IMG₃ represented in the color space CS2. The color space CS2 may be a BT.2020 color space, which has a color gamut wider than that of a P3 color space.

In some embodiments, an EOTF is applied for converting the second image data into image data represented in the first color space. Next, a color correction matrix is used for modifying the converted second image data to generate the third image data. For example, the processing block 331 can convert the image data IMG₂ into the image data IMG_{X} based on the EOTF invf1, which may be an inverse of the OETF f1. The processing block 331 can apply color correction to the image data IMG_{X} through gamut mapping to generate the image data IMG₃ represented in the color space CS2.

At operation 406, dynamic range adjustment is performed on the third image data to generate fourth image data. The bit depth of the fourth image data is greater than the bit depth of the third image data. For example, the processing block 332 can perform dynamic range adjustment on the image data IMG₃ to generate the image data IMG₄. To recover the range of pixel value, the processing block 332 can expand the image data range in bit depth per pixel. Thus, the bit depth of the image data IMG₄ is greater than the bit depth of the image data IMG₃.

In some embodiments, the dynamic range adjustment includes inverse tone mapping and luminance remapping. For example, the processing block 332 may perform inverse tone mapping on the image data IMG₃ to produce the image data IMG_{Y}. Also, the processing block 332 may remap the luminance values of the image data IMG_{Y} to a predetermined luminance range, thereby generating the image data IMG₄. The image data IMG₄ can have the remapped luminance values that span the predetermined luminance range.

At operation 408, the fourth image data is converted into the HDR image data based on a second OETF function for HDR content. For example, the processing block 333 can convert the image data IMG₄ into the image data IMG_{H} based on the OETF f2, which may be the OETF f_hdr10 shown in FIG. 2.

As those skilled in the art can appreciate the operation of the method 400 after reading the above paragraphs directed to FIG. 1 through FIG. 3, further description is omitted here for brevity.

Referring again to FIG. 1, in some embodiments, the ISP 112 may utilize dynamic range decompression and an OETF f3 to generate the output image data IMG_{D} having a high dynamic range. The OETF f3 supports HDR content and exhibits a relatively gentle slope in the low luminance range. The image processing system 110 can output the video stream VS1 having a dynamic range substantially equal to that of raw image data captured by the image sensor 120.

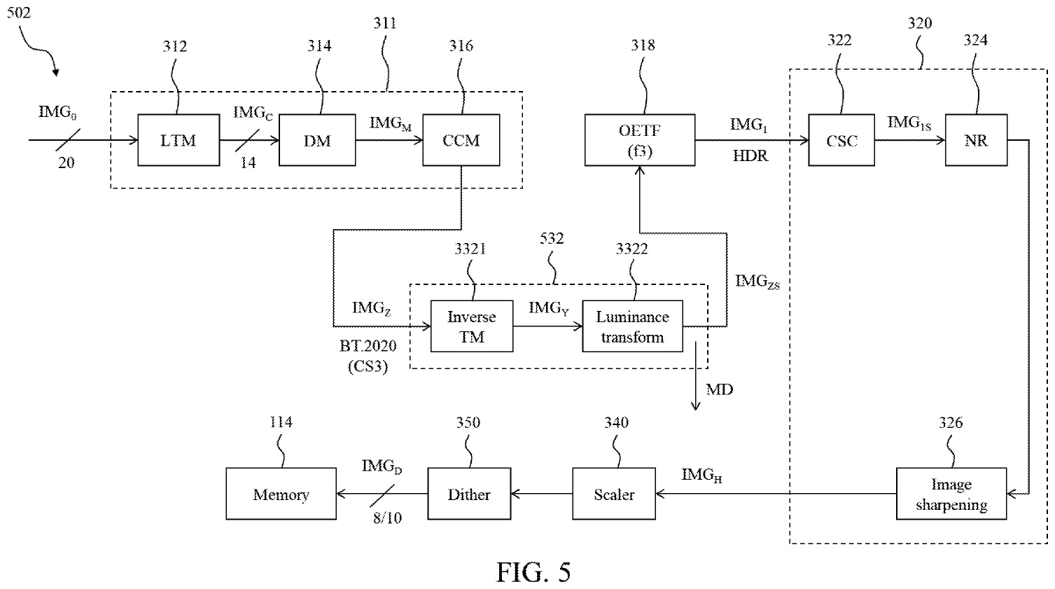

FIG. 5 is a diagram illustrating an exemplary ISP pipeline at the ISP end 11 shown in FIG. 1 in accordance with some embodiments of the present disclosure. The ISP pipeline 502 can be implemented by the ISP 112 shown in FIG. 1. For example, the ISP 112 shown in FIG. 1 may include hardware elements, software elements, or a combination of both hardware and software elements that facilitate the performance of various stages/blocks in the ISP pipeline 502. The structure of the ISP pipeline 502 is similar to that of the ISP pipeline 302 shown in FIG. 3 except that an HDR mastering block, i.e. the processing block 532, is arranged between the processing blocks 311 and 318.

The ISP pipeline 502 is configured to utilize the OETF f3 shown in FIG. 1 to produce HDR video content without introducing serious artifacts. For example, the OETF f3 is implemented using the OETF f_hlg shown in FIG. 2. Those skilled in the art will appreciate that other HDR OETFs, each of which exhibits a relatively gentle slope in the low luminance range, can be used as the OETF f3 without departing from the scope of the present disclosure.

In the present embodiment, the processing block 311 in the ISP pipeline 502 can perform tone mapping and color correction on the input image data IMG₀ to generate the image data IMG_{Z}, which is represented in a color space CS3 having a color gamut compatible with HDR content. The bit depth of the image data IMG_{Z} is less than the bit depth of the input image data IMG₀. For example, the TM block 312 can perform tone mapping, e.g. local tone mapping (LTM), on the input image data IMG₀ to generate the image data IMG_{C}. The DM block 314 can perform the process of demosaicing the image data IMG_{C} to get full-color image data IMG_{M}. The CCM block 316 can apply color correction to the image data IMG_{M} through gamut mapping to generate the image data IMG_{Z} represented in the color space CS3. The color space CS3 has a color gamut compatible with HDR content. For example, the color space CS3 may be a BT.2020 color space supported by the HDR standard.

The processing block 532 is configured to performing dynamic range adjustment on the image data IMG_{Z} to generate the image data IMG_{ZS} having a high dynamic range. The dynamic range adjustment includes, but is not limited to, inverse tone mapping and luminance remapping. Consequently, the image data IMG_{ZS} and the input image data IMG₀ may be of equal bit depth. In the example shown in FIG. 5, the processing block 532 is implemented using the inverse tone mapping block 3321 and the luminance transform block 3322 shown in FIG. 3. The inverse tone mapping block 3321 can perform inverse tone mapping on the image data IMG_{Z} to produce image data IMG_{Y} having a greater bit depth than that of the image data IMG_{Z}. The luminance transform block 3322 can remap luminance values of the image data IMG_{Y} to a predetermined luminance range, thereby generating the image data IMG_{ZS} having the remapped luminance values that span the predetermined luminance range. In some embodiments, the processing block 532 can be configured to output the metadata MD, which includes information about the predetermined luminance range.

The OETF block 318 is configured to convert the image data IMG_{ZS} into the image data IMG₁ based on the OETF f3, such as the OETF f_hlg shown in FIG. 2. The stage 320 is configured to perform image enhancement on the image data IMG₁ and accordingly generate HDR image data, i.e. the image data IMG_{H}. The image enhancement may include at least one of noise reduction and image sharpening. Note that the image data IMG₁ is produced using the OETF f3, which is an HDR OETF having a relatively gentle slope in the low luminance range. Therefore, the image enhancement performed on the image data IMG₁ would not introduce serious artifacts into the image data IMG_{H}. In other words, the ISP pipeline 502 can generate HDR image data with few artifacts.

In operation, the processing block 311 can convert the input image data IMG₀ into the image data IMG_{Z} encoded in a BT.2020 color space. The inverse tone mapping block 3321 can perform the inverse local tone mapping on the image data IMG_{Z} to recover the range of pixel value compressed in the processing block 311. The luminance transform block 3322 can adjust the luminance values of the image data IMG_{Y}, and generate the image data IMG_{ZS} having adjusted luminance values. The processing block 332 can be further configured to generate the metadata MD including parameters indicative of image/video quality, such as tone mapping parameter(s) and/or information about luminance remapping. The metadata MD can be incorporated into the encoded video stream VS1 shown in FIG. 1.

Next, the OETF block 318 can apply the OETF f3 (e.g. the OETF f_hlg shown in FIG. 2) to the image data IMG_{ZS}, thereby producing the image data IMG₁ compliant with the HDR standard. The stage 320 can perform image enhancement on the image data IMG₁, and accordingly generate the image data IMG_{H}. Note that the metadata MD generated in the processing block 532 may include image enhancement parameter(s) used in the stage 320.

As those skilled in the art can appreciate the operation of each stage/block in the ISP pipeline 502 after reading the above paragraphs directed to FIG. 1 through FIG. 4, similar description is not repeated here for brevity.

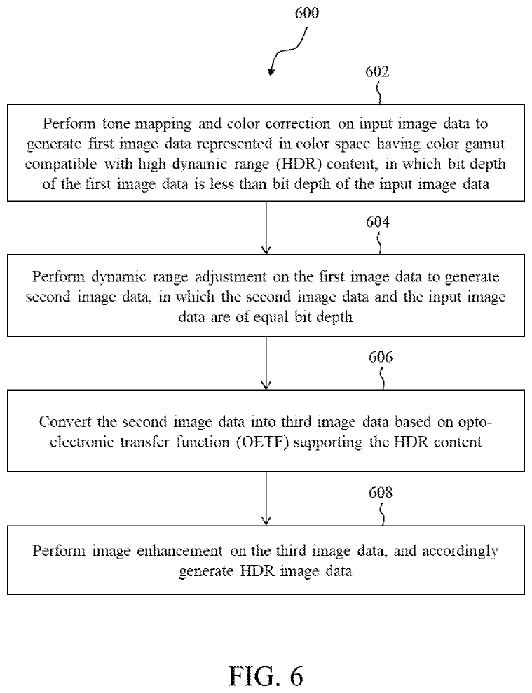

FIG. 6 is a flow chart of an exemplary method for generating HDR image data in accordance with some embodiments of the present disclosure. The operation described above with reference to the ISP pipeline 502 shown in FIG. 5 may be summarized in the flow chart of FIG. 6. For illustrative purposes, the method 600 is described below with reference to the ISP pipeline 502 shown in FIG. 5. Note that the method 600 can be employed by the ISP 112 shown in FIG. 1 for generating HDR image data without departing from the scope of the present disclosure. Moreover, in some embodiments, other operations in the method 600 can be performed.

At operation 602, tone mapping and color correction are performed on input image data to generate first image data represented in a color space having a color gamut compatible with HDR content. The bit depth of the first image data is less than the bit depth of the input image data. For example, the processing block 311 may perform tone mapping and color correction on input image data IMG₀ to generate the image data IMG_{Z} represented in the color space CS3 (e.g. a BT.2020 color space) supported by the HDR standard. The image data IMG_{Z} has a smaller bit depth than the input image data IMG₀.

At operation 604, dynamic range adjustment is performed on the first image data to generate second image data with high dynamic range. The second image data and the input image data are of equal bit depth. For example, the processing block 532 can perform dynamic range adjustment on the image data IMG_{Z} to generate the image data IMG_{ZS}. To recover the range of pixel value, the processing block 532 can expand the image data range in bit depth per pixel. The image data IMG_{ZS} and the input image data IMG₀ may have the same number of bits in depth per pixel.

In some embodiments, the dynamic range adjustment includes inverse tone mapping and luminance remapping. For example, the processing block 532 may perform inverse tone mapping on the image data IMG_{Z} to produce the image data IMG_{Y}. Also, the processing block 532 may remap the luminance values of the image data IMG_{Y} to a predetermined luminance range, thereby generating the image data IMG_{ZS}. The image data IMG_{ZS} can have the remapped luminance values that span the predetermined luminance range.

At operation 606, the second image data is converted into third image data based on an OETF supporting the HDR content. For example, the OETF block 318 can convert the image data IMG_{ZS} into the image data IMG₁ based on the OETF f3, which may be the OETF f_hlg shown in FIG. 2.

At operation 608, image enhancement is performed on the third image data to generate the HDR image data. For example, the stage 320 may receive the image data IMG₁ represented in the color space CS3 (e.g. the BT.2020 color space), and perform image enhancement on the image data IMG₁ to generate the image data IMG_{H}.

As those skilled in the art can appreciate the operation of the method 600 after reading the above paragraphs directed to FIG. 1 through FIG. 5, further description is omitted here for brevity.

With the use of the proposed image processing scheme, the ISP end can generate HDR image data without, or almost without, introducing artifacts caused by image enhancement. The ISP end can provide the display end with an HDR video stream having a dynamic range equal to that of the image stream captured by the image sensor. Moreover, the proposed image processing scheme can realize an ISP-guided video system or a quality-aware end-to-end video system, which outputs metadata from the ISP end to the display end for further image processing.

The foregoing outlined features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for generating high dynamic range (HDR) image data, comprising:
performing image enhancement on first image data represented in a first color space, and accordingly generating second image data, wherein the first image data is produced using a first opto-electronic transfer function for standard dynamic range (SDR) content;
converting the second image data into third image data represented in a second color space, wherein a color gamut of the second color space is wider than a color gamut of the first color space;
performing dynamic range adjustment on the third image data to generate fourth image data, wherein the bit depth of the fourth image data is greater than the bit depth of the third image data; and
converting the fourth image data into the HDR image data based on a second opto-electronic transfer function for HDR content.

2. The method of claim 1, wherein the step of converting the second image data into the third image data comprises:
converting the second image data into fifth image data represented in the first color space based on an electro-optical transfer function; and
applying color correction to the fifth image data through gamut mapping to generate the third image data represented in the second color space.

3. The method of claim 1, wherein the step of performing the dynamic range adjustment on the third image data comprises:
performing inverse tone mapping on the third image data to produce fifth image data; and
remapping luminance values of the fifth image data to a predetermined luminance range, thereby generating the fourth image data having the remapped luminance values that span the predetermined luminance range.

4. The method of claim 3, further comprising:
performing tone mapping and color correction on input image data to generate sixth image data represented in the first color space, wherein the input image and the fifth image data are of equal bit depth; and
applying the first opto-electronic transfer function to the sixth image data to produce the first image data with a standard dynamic range.

5. The method of claim 3, further comprising
outputting metadata including information about the predetermined luminance range to a display device.

6. The method of claim 1, wherein the image enhancement comprises at least one of noise reduction and image sharpening.

7. The method of claim 1, further comprising:
outputting metadata including at least one parameter used in the image enhancement to a display device.

8. A method for generating high dynamic range (HDR) image data, comprising:
performing tone mapping and color correction on input image data to generate first image data represented in a color space having a color gamut compatible with HDR content, wherein the bit depth of the first image data is less than the bit depth of the input image data;
performing dynamic range adjustment on the first image data to generate second image data, wherein the second image data and the input image data are of equal bit depth;
converting he second image data into third image data based on an opto-electronic transfer function supporting the HDR content; and
performing image enhancement on the third image data, and accordingly generating the HDR image data.

9. The method of claim 8, wherein the opto-electronic transfer function is a hybrid log-gamma (HLG) transfer function.

10. The method of claim 8, wherein the step of performing the dynamic range adjustment on the first image data comprises:
performing inverse tone mapping on the first image data to produce fourth image data; and
remapping luminance values of the fourth image data to a predetermined luminance range, thereby generating the second image data having the remapped luminance values that span the predetermined luminance range.

11. The method of claim 10, further comprising:
outputting metadata including information about the predetermined luminance range to a display device.

12. The method of claim 8, wherein the image enhancement comprises at least one of noise reduction and image sharpening.

13. The method of claim 12, further comprising:
outputting metadata including at least one parameter used in the image enhancement to a display device.

14. An image processing system comprising:
a memory configured to store output image data corresponding to input image data captured by an image sensor; and
an image signal processor, coupled to the memory, the image signal processor being configured to:
convert the input image data into first image data represented in a first color space based on a first opto-electronic transfer function supporting a first dynamic range;
perform image enhancement on the first image data to generate second image data;
convert the second image data into third image data represented in a second color space, wherein a color gamut of the second color space is wider than a color gamut of the first color space;
perform dynamic range adjustment on the third image data to generate fourth image data, wherein the bit depth of the fourth image data is greater than the bit depth of the third image data; and
apply a second opto-electronic transfer function to the fourth image data, and accordingly generate the output image data, wherein the second opto-electronic transfer function supports a second dynamic range wider than the first dynamic range.

15. The image processing system of claim 14, wherein the first opto-electronic transfer function supports standard dynamic range (SDR) content, and the second opto-electronic transfer function supports high dynamic range (HDR) content.

16. The image processing system of claim 14, wherein converting the second image data into the third image data comprises:
converting the second image data into fifth image data represented in the first color space based on an electro-optical transfer function; and
applying color correction to the fifth image data through gamut mapping to generate the third image data represented in the second color space.

17. The image processing system of claim 14, wherein performing the dynamic range adjustment on the third image data comprises:
performing inverse tone mapping on the third image data to produce fifth image data; and
remapping luminance values of the fifth image data to a predetermined luminance range, thereby generating the fourth image data having the remapped luminance values that span the predetermined luminance range.

18. The image processing system of claim 17, wherein the fifth image data and the input image data are of equal bit depth.

19. The image processing system of claim 17, wherein the image signal processor is further configured to output metadata including information about the predetermined luminance range to a display device.

20. The image processing system of claim 14, wherein the image enhancement comprises at least one of noise reduction and image sharpening.
